(19) United States
(12) Patent Application Publication
(10) Pub. No.: US 2015/0369277 A1
(43) Pub. Date: Dec. 24, 2015

(54) Universal Joint Jaw, Assembly for a Double Universal Ball Joint and Machining Method

(71) Applicant: ROBERT BOSCH AUTOMOTIVE STEERING VENDÔME, Vendôme (FR)

(72) Inventors: Laurent FEVRE, Saint-Sulpice-de-Pommeray (FR); Vincent Eymery, Lance (FR)

(73) Assignee: Robert Bosch Automotive Steering Vendôme, Vendôme (FR)

(21) Appl. No.: 14/766,894

(22) PCT Filed: Feb. 10, 2014
(86) PCT No.: PCT/EP2014/052502

§ 371 Date: Aug. 10, 2015

(30) Foreign Application Priority Data
Feb. 11, 2013 (FR) 1351132

(51) Int. Cl. F16C 11/06

(52) U.S. Cl. CPC F16C 11/06

(57) ABSTRACT

A double universal ball joint assembly comprises a universal joint jaw forming a first part, and a ball element which can either be integrated in the jaw or form a second part assembled to the first part. The jaw comprises a base having a cavity of contant cross-section for accommodating a shaft end, the cavity defining a geometric insertion axis. Two side flanges are connected to the base and face one another to define a space for receiving a universal joint journal cross, the two flanges each being provided with a bearing recess for guiding the universal joint journal cross A connecting bridge that connects the two side flanges comprises a through-hole, which has a cross-section located at all points radially outside of, or coinciding with, a geometric wall of the cavity of the base, which enables the cavity to be machined by broaching.

### TECHNICAL FIELD OF THE INVENTION

The present invention relates to a connection with two universal joints and a guiding ball joint, and in particular such a connection designed to connect two shafts of a motor vehicle steering column. It more particularly relates to an assembly between a universal joint jaw and a ball joint element of such a connection. This type of connection with two universal joints makes it possible to transmit the rotation between two unaligned rotating shafts, and more specifically in the application to a steering column, between the shaft supporting the steering wheel and the shaft supporting the rack pinion.

### BACKGROUND OF THE INVENTION

In a known manner, the single universal joint has the drawback of not being homokinetic, inasmuch as the ratio between output and input speed is not constant over a revolution and undergoes a cyclic variation with an amplitude that is greater when the angle between the shafts is large. This flaw may be corrected to a certain extent with a transmission mechanism with two universal joints positioned such that their nonlinearities compensate one another and are accessible. To still better control this linearity flaw, it is also known to center the double universal joint by providing a central ball joint between the two universal joint jaws. A device of this type is for example described in document FR 2,730,774 A1. The device comprises a central jaw connected to two end jaws by two journal crosses, each end jaw comprising a base having a cavity housing one shaft end, and two side wings connected to the base, the two wings facing one another and delimiting a volume between them for receiving a universal joint journal cross. The two end jaws are further connected to one another by a ball joint made up of a spherical ball joint element connected on one of the end jaws and a cylindrical complementary ball joint element attached on the other end jaw. The connection between the end jaws and the central ball joint is done by means of posts situated at the end of the wings of the jaws. This connection allows local crushing of the posts and contributes to decreasing operating play.

This type of connection between ball joint and end jaw is not, however, fully satisfactory inasmuch as it may create a significant off-centering flaw between the ball joint and the axis of the transmission, creating stresses in the system. The crimping of the ball joint support may furthermore deteriorate the border of the journal cross bearing, which is located very close by. Lastly, the connection does not have any redundancy, which may be detrimental for a safety member.

Document FR 2,402,803 discloses a universal joint jaw made in one part, comprising: two side wings connected to a base, the two wings facing one another and delimiting a volume between them for receiving a universal joint journal cross, the two wings each being provided with a bearing housing for guiding the universal joint journal cross, the two housings defining a pivot axis of the journal cross, perpendicular to a longitudinal axis of the jaw, the universal joint jaw further comprising a connecting bridge connecting the two side wings, the two bearing housings being situated, in reference to the longitudinal axis, between the base and the connecting bridge, the connecting bridge comprising a through hole coaxial with the longitudinal axis. However, the universal joint jaw thus formed is difficult to fasten to a shaft and with the required precision. According to one embodiment, the wings each extend by a tab curved radially outward and on which the shaft is fastened. According to another embodiment, it is provided to reduce the fastening between the shaft and the universal joint jaw by welding, riveting or using a screw and nut system. These solutions are complex to implement at a fast pace, on the one hand, and relatively unsatisfactory regarding the resulting alignment between the jaw and the shaft on the other hand.

It is also possible to form the end jaw and the associated ball joint element in a single piece, as for example suggested in document D 198 18 570. However, such a configuration requires the use of a non-through tool for machining of the cavity of each jaw designed to receive a shaft end, which for example excludes pinning. The part is then manufactured at a slower pace, resulting in a high cost.

Document US 2008/0227555 discloses a universal joint jaw made in a single part and comprising: a base having a cavity housing a shaft end, the cavity defining a geometric insertion axis for a shaft end, the cavity having a constant section between two open axial ends, a geometric enclosure of the cavity being defined by a generatrix parallel to the geometric insertion axis and describing the constant section of the cavity of the base, and two side wings connected to the base, the two wings facing one another and delimiting a volume between them for receiving a universal joint journal cross, the two wings each being provided with a guide bearing housing for the universal joint journal cross, the two housings defining a pivot axis of the journal cross, perpendicular to the geometric insertion axis, the universal joint jaw made in a single part further comprising a connecting bridge connecting the two side wings, the two bearing housings being situated between the base and the connecting bridge in reference to the insertion axis. However, in this configuration as well, the end jaw and the associated ball joint element are formed in a single piece, which requires the use of a non-through tool to machine the cavity intended to receive a shaft end, and for example excludes pinning. The part is then manufactured at a slower pace, resulting in a high cost.

### BRIEF DESCRIPTION OF THE INVENTION

The invention aims to resolve the drawbacks of the state of the art and to propose a simplified assembly between a universal joint jaw and a ball joint element, which guarantees a better alignment of the ball joint relative to the shafts connected by the double universal joint incorporating the assembly, at a lower cost.

To achieve the above aim, according to a first aspect of the invention, proposed is a universal joint jaw made in a single piece and comprising:
a base having a cavity for housing a shaft end, the cavity defining a geometric insertion axis for a shaft end, the cavity having a constant section between two open axial ends, a geometric enclosure of the cavity being defined by a generatrix parallel to the geometric insertion axis and describing the constant section of the cavity of the base,
two side wings connected to the base, the two wings facing one another and delimiting a volume between them for receiving a universal joint journal cross, the two wings each being provided with a guide bearing housing for the universal joint journal cross, the two housings defining a pivot axis of the journal cross, perpendicular to the geometric insertion axis, and
a connecting bridge connecting the two side wings, the two bearing housings being situated between the base and the connecting bridge in reference to the insertion axis, the connecting bridge comprising a through hole coaxial with the insertion axis, the through hole having a section situated in all points radially outside, or coinciding with, the geometric enclosure of the cavity of the base.

The through hole is designed either to constitute a ball joint element itself, or to house such a ball joint element. The bridge connecting the two wings stiffens the structure. The single-piece design having, in a same axis, an insertion cavity for a shaft end and a through hole for a ball joint element guarantees good precision of the alignment of the ball joint element and the shaft and using particularly simple means. Stiffening and precision work together to limit the wear of the parts over their lifetime.

Furthermore, by providing a cavity with a constant section to house the shaft end, the cavity being open at both of its ends and having a section smaller than that of the through hole situated in its extension, it is possible to machine the cavity through a pinning operation using a pin passing, during or after the cutting operation, through the through hole. The precision of this machining method also contributes to the precision of the assembly. The method also makes it possible to reduce the time of the manufacturing cycle and the cost.

The part making up the universal joint jaw may be universal, in that it may adapt both to a male ball joint element and a female ball joint element, owing to the interface formed by the through hole.

Preferably, the section of the cavity of the base is noncircular. It is thus possible to provide shape locking between the universal joint jaw and the end of the shaft designed to be inserted into the cavity. It is in particular possible to provide that the cavity of the base is fluted.

It is possible to consider various shapes for the through hole, for example a Morse taper. However, according to one preferred embodiment, the section of the through hole is constant, and preferably noncircular. According to one particularly advantageous embodiment, the section of the through hole is situated in all points coinciding with the geometric enclosure of the cavity of the base. It is then possible to form the housing cavity of the shaft end and the through hole during a same pinning operation.

According to another embodiment, the through hole has a smooth inner cylindrical wall and thus itself constitutes a female ball joint element.

According to another aspect of the invention, the invention relates to an assembly for a double universal ball joint, comprising: a universal joint jaw as described above, making up the first part, and a ball joint element that may be either a female ball joint element made up of the through hole of the jaw, or a male or female ball joint element forming a second part assembled to the universal joint jaw and having an end with a shape complementary to the through hole and housed in the through hole.

The connection between the universal joint jaw and the ball joint element is preferably obtained with no additional parts, and in particular without screws. Preferably, the end of the universal joint element is braced in the through hole.

According to another alternative, the ball joint element is screwed into the through hole. A brake may be provided to prevent any risk of unscrewing of the parts.

Preferably, the ball joint element has an axial positioning shoulder bearing on the bridge of the universal joint jaw.

According to one embodiment, the bridge of the universal joint jaw has crimping for maintaining the ball joint element. Any risk of loosening of the connection is thus avoided, and redundancy is established in the connection.

According to another aspect of the invention, the invention relates to a double universal joint comprising at least one assembly or a jaw as described above. The assembly makes it possible to ensure good centering of the ball joint relative to the insertion axis, resulting in reduced off-centering flaws of the system, thus leading to fewer stresses in the system.

In particular, it relates to a double universal joint comprising two assemblies as previously described, the ball joint element of one of the two assemblies being housed, directly or indirectly, in the ball joint element of the other of the two assemblies.

Preferably, the ball joint jaws of the two assemblies are identical. This results in a considerable advantage in terms of providing parts before they are assembled and in terms of manufacturing cost.

According to another aspect of the invention, the invention relates to a double universal joint comprising at least one first universal joint jaw as previously described, the through hole of which has a smooth wall, and a second universal joint jaw comprising a male ball joint element housed, directly or indirectly, in the through hole of the first universal joint jaw, which constitutes a female ball joint element.

Preferably, the double universal joint comprises a sliding plastic pad inserted between a spherical portion of the ball joint element and a cylindrical portion of another ball joint element, the pad having a lower cavity for housing the spherical portion and an outer wall sliding in the cylindrical portion of the other ball joint element. The pad limits friction. It is preferably equipped with elastic tongues, or more generally with elastically deformable elements that react functional play.

According to another aspect of the invention, the invention relates to a method for machining a universal joint jaw as previously described, according to which method the cavity housing a shaft end is obtained by pinning using a pin which, during or after the pinning operation, passes through the through hole.

Preferably, the cavity housing a shaft end and the through hole are obtained by a same pinning operation with the same pin. This method is particularly cost-effective.

### BRIEF DESCRIPTION OF THE DRAWINGS

Other features and advantages of the invention will emerge from reading the following description, done in reference to the appended figures, which illustrate:

FIG. 1, an exploded view of a double universal joint according to a first embodiment of the invention;

FIG. 2, a partial sectional view along a first cutting plane of the double universal joint according to the first embodiment of the invention, in a first angular position;

FIG. 3, a partial sectional view along a second cutting plane perpendicular to the first cutting plane of the double universal joint according to the first embodiment of the invention, in a second angular position;

FIG. 4, a partial sectional view of a jaw of the double universal joint according to the first embodiment of the invention;

FIG. 5, a partial sectional view of a male ball joint element of the double universal joint according to the first embodiment of the invention;

FIG. 6, a partial sectional view of a female ball joint element of the double universal joint according to the first embodiment of the invention;

FIG. 7, a front view of a pad inserted between the male ball joint element of FIG. 5 and the female ball joint element of FIG. 6;

FIG. 8, a sectional view of the pad of FIG. 7;

FIG. 9, a detailed sectional view of the articulation between the male ball joint element of FIG. 5 and the female ball joint element of FIG. 6 by means of the pad of FIG. 7, and the respective connections with two jaws according to FIG. 4;

FIG. 10, a partial sectional view of an assembly screwed between a universal joint jaw and a ball joint element according to a second embodiment of the invention;

FIG. 11, a partial sectional view of a universal joint jaw incorporating a ball joint element according to a third embodiment of the invention;

FIG. 12, an isometric perspective view of a jaw according to a fourth embodiment of the invention;

FIG. 13, an isometric perspective view of a male ball joint element according to the fourth embodiment of the invention;

FIG. 14, an isometric perspective view of a female ball joint element according to the fourth embodiment of the invention;

FIG. 15, a partial sectional view of a double universal ball joint according to a fifth embodiment of the invention.

For greater clarity, identical elements are identified using identical reference signs in all of the figures.

### DETAILED DESCRIPTION OF THE INVENTION

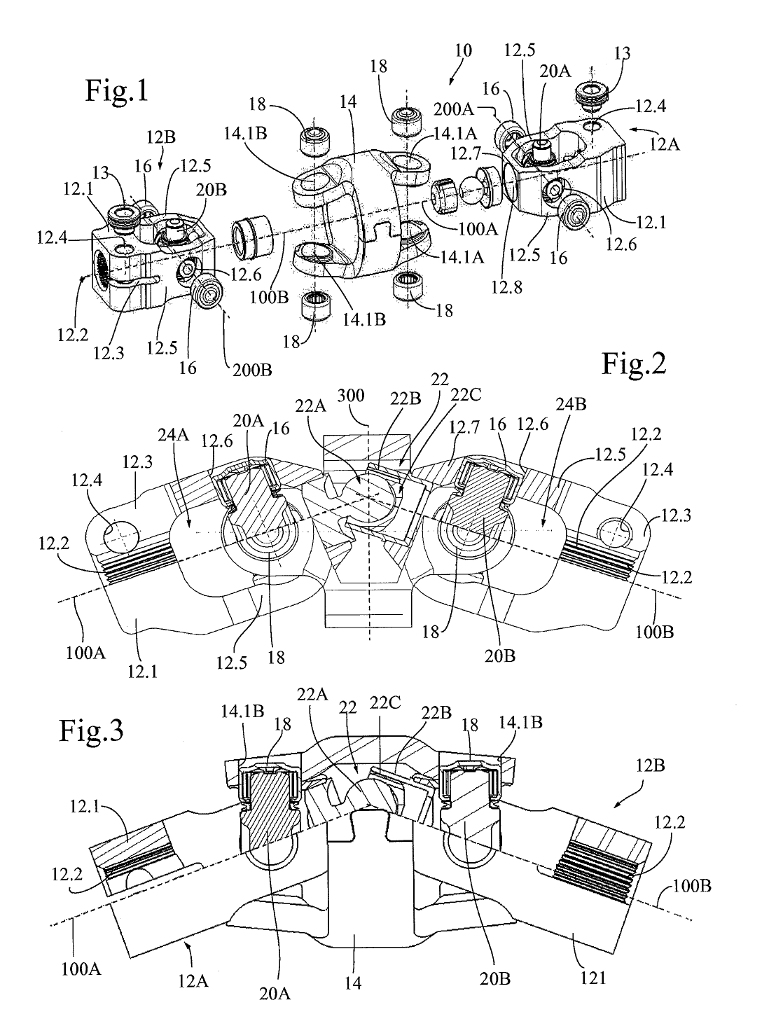

FIGS. 1 to 3 show the entirety of a double universal joint connection 10 made up of two end universal joint jaws 12A, 12B, connected to each other by a central intermediate double jaw 14, with eight drawn cup needle bearings 16, 18, two journal crosses 20A, 20B and a ball joint 22.

The two end jaws 12A, 12B, which are identical in this first embodiment, are designed each to be rigidly fastened to an end of a shaft (not shown) in a motor vehicle steering system. To that end, each jaw 12A, 12B has a base 12.1 provided with a fluted cavity 12.2 defining an insertion axis 100A, 100B for the associated shaft end. The cavity 12.2 is open on either side, and slotted at 12.3 along a tightening plane. The jaw 12A, 12B is also provided with a bore 12.4 to allow the insertion of a screw or tightening bolt 13 to close the slot 12.3 and pinch the shaft end. The jaw 12A, 12B further has two side wings 12.5 that extend from the base 12.1 in the general direction of the insertion axis 100A, 100B, laterally on either side of the cavity 12.2 housing the shaft end, so as to face one another and laterally delimit a volume 24A, 24B between them for housing of the journal crosses 20A, 20B. Each wing 12.5 is provided with a bore 12.6 for housing one of the drawn cup needle bearings 16. The housings 12.6 of the two wings 12.5 face one another to each receive an opposite branch of the journal cross 20A, 20B, and define a pivot axis 200A, 200B of the journal cross, perpendicular to the insertion axis 100A, 100B. In a manner known in itself, the other two opposite branches of each journal cross 20A, 20B are inserted into the drawn cup needle bearings 18 housed in the corresponding cylindrical bores 14.1A, 14.1B of the intermediate double jaw 14.

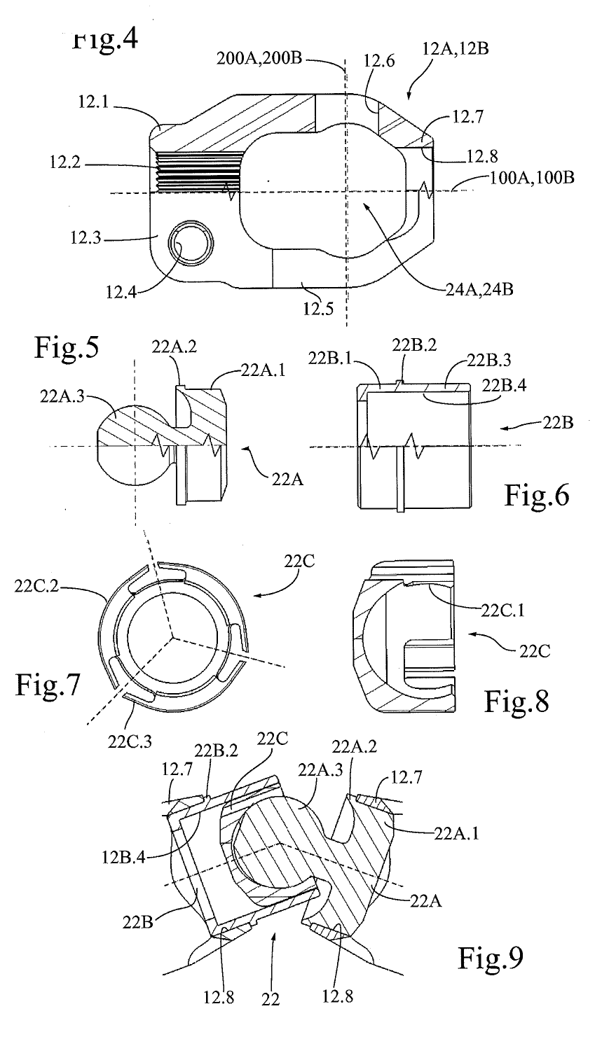

As illustrated in detail in FIG. 4, the two wings 12.5 of the jaw are connected by a material bridge 12.7 extending substantially parallel to the pivot axis 100A, 100B, the base 12.1 and the bridge 12.7 being situated, in reference to the insertion axis 100A, 100B, on either side of the wings 12.5 and the volume 24A, 24B housing the journal cross 20A, 20B. The bridge 12.7 has a hole 12.8, preferably cylindrical, positioned in the axial alignment of the cavity 12.2 and open on either side. This hole 12.8 makes it possible to receive a ball joint element 22A, 22B, which may be male or female. The male ball joint element 22A, shown in FIG. 5, has a first cylindrical end 22A.1 designed to be inserted into the hole 12.8 of the associated jaw 12A, a stop shoulder 22A.2 designed to bear against the bridge 12.7 at the rims of the hole 12.8, and a second spherical end 22A.3. The female ball joint element 22B, illustrated in FIG. 6, is made up of a cylindrical bush having a stop collar 22B.2 separating a cylindrical bottom portion 22B.1 designed to be inserted into the hole 12.8 and a protruding portion 22B.3 remaining outside the hole, the collar 22B.2 bearing, at the assembly, on the bridge 12.7 of the end jaw 12B at the perimeter of the hole 12.8. The bush 22B has a smooth cylindrical inner wall 22B.4 to receive, directly or indirectly, the spherical end 22A.3 of the male ball joint element 22.A. Preferably, a plastic pad 22C, shown in FIGS. 7 and 8, completes the ball joint 22 and provides the interface between the male and female ball joint elements 22A, 22B. This pad 22C has a spherical cavity 22C.1 to receive and capture the spherical end 22A.3 of the male ball joint element 22A, and an outer surface 22C.2 allowing it to slide inside the bush along the cylindrical wall 22B.4. Preferably, this outer surface 22C.2 is provided with elastic tongues 22C.3 that are angularly equally distributed on its circumference and that bear against the cylindrical inner surface 22B.4 of the female ball joint element 22B. The pad 22C is preferably made from polyacetal, such as a polyoxymethylene POM, polyamide PA or polyether ether ketone PEEK, or another thermoplastic material having good mechanical and antifriction properties.

Each end jaw 12A, 12B is formed in a single piece made from metal, for example aluminum alloy or steel. Remarkably, the hole 12.8 has a diameter larger than the outer diameter of the flutes of the cavity 12.2, allowing machining of the cavity 12.2 using a pin which, during or after the cutting operation, passes through the hole 12.8.

Each of the ball joint elements 22A, 22B is connected to the corresponding jaw 12A, 12B preferably by bracing the cylindrical part 22A.1, 22B.1 of the ball joint element in the corresponding cylindrical hole 12.8, as shown in FIG. 9. Crimping may be done to secure the connection and prevent any removal of the ball joint element 22A, 22B in case of loss of bracing.

The device operates as follows. When one of the shafts connected to one of the jaws rotates around its axis 100A, 100B, the rotation and the torque are transmitted to the other shaft by end jaws 12A, 12B, journal crosses 20A, 20B and the intermediate jaw 14. The ball joint 22 does not contribute to this torque transmission, but guarantees, with very low error, the quality of the angles formed by each of the axes 100A, 100B with a median geometric plane 300 connected to the intermediate jaw 14. During operation, the pad 22C oscillates around the sphere of the male ball joint element 22A and slides inside the cylinder 22B.4 of the female ball joint element 22B. The tongues 22C.3 make it possible to hide the necessary operating play between the two ball joint elements 22A, 22B and to ensure a minimal stiffness during operation of the double universal joint. They are sized so as to obtain a sufficient thickness while generating acceptable friction during operation of the double universal joint.

Many alternatives are possible.

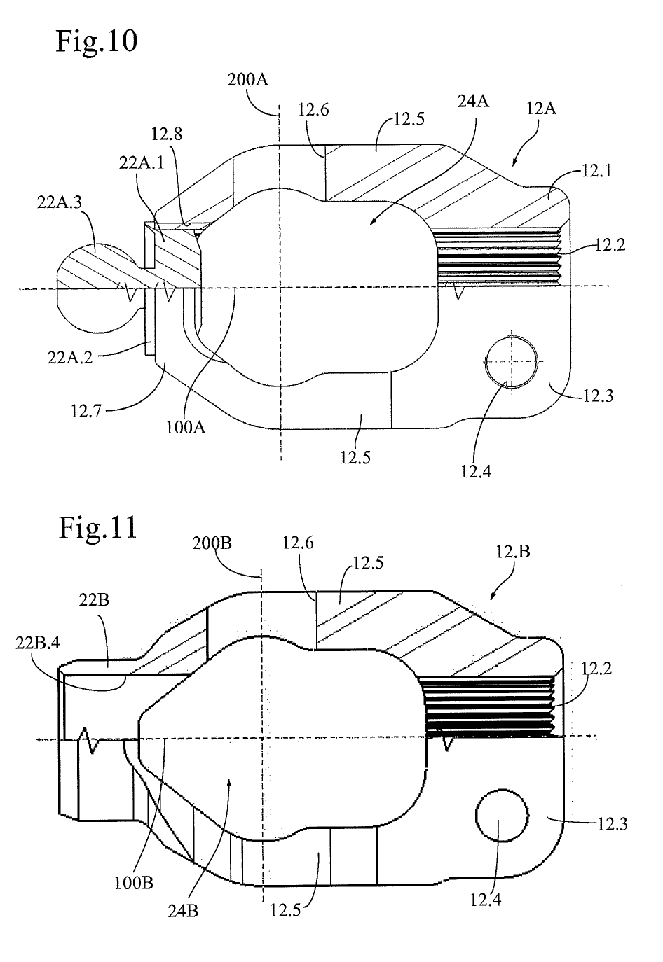

According to the embodiment shown in FIG. 10, it is possible to provide a screwed connection between one and/or the other of the ball joint elements 22A, 22B (in the figure, the male ball joint element 22A) and the associated end jaw 12A, 12B. The end 22A.1 (or 22B.1, depending on the case) of the ball joint element 22A, 22B is threaded, and the hole 12.8 of the corresponding end jaw 12A, 12B is tapped. The screwing of the ball joint element into the jaw is done until the shoulder 22A.2, 22B.2 of the ball joint element abuts on the bridge 12.7 of the jaw. To avoid loosening, a deformation or thread lock may be applied to the connection. To allow machining of the fluted cavity 12.2 by pinning, the inner thread diameter of the hole 12.8 is situated radially outside the bottom flute diameter of the cavity 12.2.

FIG. 11 shows an alternative of the jaw 12B associated with the female ball joint element. In the case at hand, the female ball joint element 22B and the end jaw 12B are made in a single piece. The jaw 12B incorporates the inner cylindrical wall 22B.4 in contact with the plastic pad 22C. In order to allow machining of the cavity 12.2 by pinning, the diameter of the cylinder 22B.4 is preferably larger than the largest flute bottom diameter. The universal joint jaw connected to the male ball joint is preferably identical to that of the first or second embodiment.

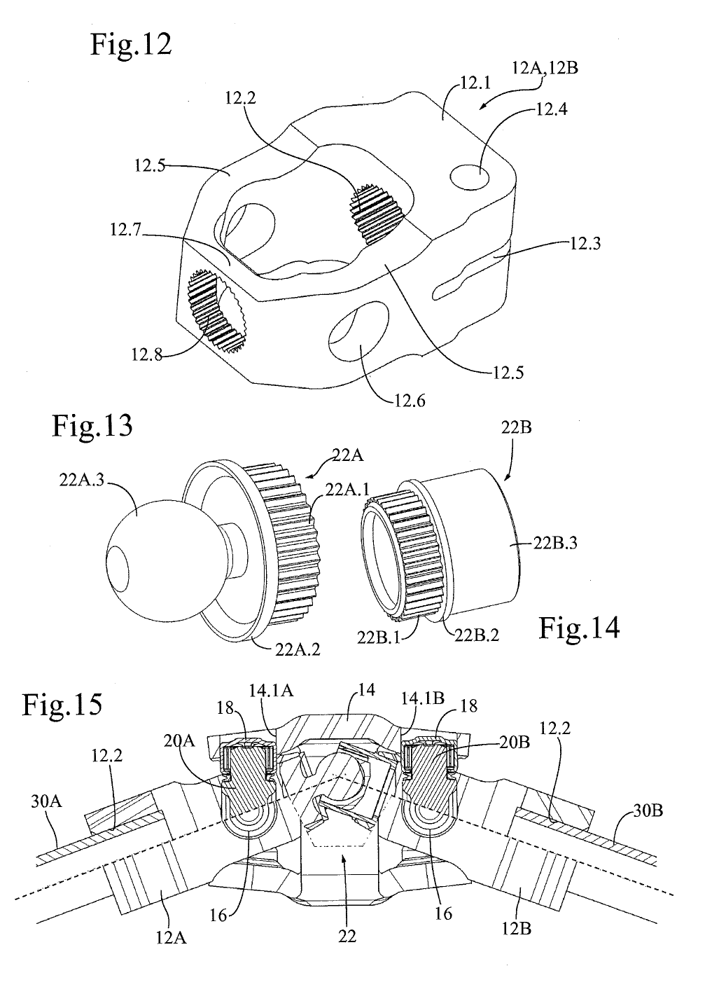

FIGS. 12 to 14 illustrate one preferred alternative, in which the connection between the ball joint element 22A, 22B and the associated jaw 12A, 12B is identical to the connection between the jaw 12A, 12B and the shaft end. In the figures, fluted connections are shown, but the principle can be generalized to other connection profiles with a noncircular section. This arrangement offers the advantage of allowing machining of the hole 12.8 and the cavity 12.2 in a single pinning operation, resulting in an increased manufacturing pace and optimal precision in the alignment of the cavity 12.2 and the hole 12.8. The ball joint elements 22A, 22B have an end 22A.1, 22B.1 with a shape conjugated to that of the associated hole 12.8.

According to the alternative of FIG. 15, the connection between the jaw 12A, 12B and shaft end 30A, 30B can be braced, without being secured by pinching, in which case the slot 12.3 and the bore 12.4 can be omitted. Other types of connection, for example by welding, are also possible.

Other alternatives are naturally possible. In particular, the sliding pad 22C can be replaced by a cylindrical fixed pad in which the sphere 22A.3 slides.

It is possible to provide for inserting an anti-vibration element braced in the cavity 12.2 between one of the transmission shafts and the associated universal joint jaw.

1. A universal joint jaw made in a single piece and comprising:
a base having a cavity for housing a shaft end, the cavity defining a geometric insertion axis for a shaft end, the cavity having a constant section between two open axial ends, a geometric enclosure of the cavity being defined by a generatrix parallel to the geometric insertion axis and describing the constant section of the cavity of the base, and
two side wings connected to the base, the two wings facing one another and delimiting a volume between them for receiving a universal joint journal cross, the two wings each being provided with a guide bearing housing for the universal joint journal cross, the two housings defining a pivot axis of the journal cross, perpendicular to the geometric insertion axis, and
a connecting bridge connecting the two side wings, the two bearing housings being situated between the base and the connecting bridge in reference to the insertion axis, wherein
the connecting bridge comprises a through hole coaxial with the insertion axis, the through hole having a section situated in all points radially outside, or coinciding with, the geometric enclosure of the cavity of the base.

2. The universal joint jaw according to claim 1, wherein the section of the cavity of the base is noncircular.

3. The universal joint jaw according to claim 2, wherein the cavity of the base is fluted.

4. The universal joint jaw according to claim 1, wherein the section of the through hole is constant, and preferably noncircular.

5. The universal joint jaw according to claim 1, wherein the section of the through hole is situated in all points coinciding with the geometric enclosure of the cavity of the base.

6. The universal joint jaw according to claim 1, wherein the through hole has a smooth inner cylindrical wall.

7. An assembly for a double universal ball joint comprising: a universal joint jaw, made in a single piece and comprising:
a base having a cavity for housing a shaft end, the cavity defining a geometric insertion axis for a shaft end, the cavity having a constant section between two open axial ends, a geometric enclosure of the cavity being defined by a generatrix parallel to the geometric insertion axis and describing the constant section of the cavity of the base, and
two side wings connected to the base , the two wings facing one another and delimiting a volume between them for receiving a universal joint journal cross , the two wings each being provided with a guide bearing housing for the universal joint journal cross, the two housings defining a pivot axis of the journal cross, perpendicular to the geometric insertion axis, and
a connecting bridge connecting the two side wings, the two bearing housing being situated between the base and the connecting bridge in reference to the insertion axis, wherein the connecting bridge comprises a through hole coaxial with the insertion axis, the through hole having a section situated in all points radially outside, or coinciding with, the geometric enclosure of the cavity of the base
wherein the assembly further comprises a ball joint element forming a second part assembled to the universal joint jaw, the ball joint element having an end with a shape complementary to the through hole and housed in the through hole.

8. The assembly according to claim 7, wherein the end of the universal joint element is braced in the through hole.

9. The assembly according to claim 7, wherein the ball joint element is screwed into the through hole.

10. The assembly according to claim 7, wherein the ball joint element has an axial positioning shoulder bearing on the bridge of the universal joint jaw.

11. The assembly according to claim 7, wherein the bridge of the universal joint jaw has crimping for maintaining the ball joint element.

12. A double universal joint comprising a universal joint jaw made in a single piece and comprising:
a base having a cavity for housing a shaft end, the cavity defining a geometric insertion axis for a shaft end, the cavity having a constant section between two open axial ends, a geometric enclosure of the cavity being defined by a generatrix parallel to the geometric insertion axis and describing the constant section of the cavity of the base, and
two side wings connected to the base , the two wings facing one another and delimiting a volume between them for receiving a universal joint journal cross , the two wings each being provided with a guide bearing housing for the universal joint journal cross, the two housings defining a pivot axis of the journal cross, perpendicular to the geometric insertion axis, and
a connecting bridge connecting the two side wings, the two bearing housings being situated between the base and the connecting bridge in reference to the insertion axis, wherein the connecting bridge comprises a through hole coaxial with the insertion axis, the through hole having a section situated in all points radially outside, or coinciding with, the geometric enclosure of the cavity of the base.

13. A double universal joint comprising two assemblies, each comprising: a universal joint jaw made in a single piece and a ball joint element forming a second part assembled to the universal joint jaw, the universal joint jaw comprising:
a base having a cavity for housing a shaft end, the cavity defining a geometric insertion axis for a shaft end, the cavity having a constant section between two open axial ends, a geometric enclosure of the cavity being defined by a generatrix parallel to the geometric insertion axis and describing the constant section of the cavity of the base, and
two side wings connected to the base , the two wings facing one another and delimiting a volume between them for receiving a universal joint journal cross , the two wings each being provided with a guide bearing housing for the universal joint journal cross, the two housings defining a pivot axis of the journal cross, perpendicular to the geometric insertion axis, and
a connecting bridge connecting the two side wings, the two bearing housings being situated between the base and the connecting bridge in reference to the insertion axis, wherein the connecting bridge comprises a through hole coaxial with the insertion axis, the through hole having a section situated in all points radially outside, or coinciding with, the geometric enclosure of the cavity of the base,
the ball joint element having an end with a shape complementary to the through hole and housed in the through hole,
wherein the ball joint element of one of the two assemblies-being is housed, directly or indirectly, in the ball joint element of the other of the two assemblies.

14. The double universal joint according to claim 13, wherein the universal joint jaws of the two assemblies are identical.

15. A double universal joint comprising a first universal joint jaw and a second universal joint jaw, wherein the first universal joint jaw is made in a single piece and comprises:
a base having a cavity for housing a shaft end, the cavity defining a geometric insertion axis for a shaft end, the cavity having a constant section between two open axial ends, a geometric enclosure of the cavity being defined by a generatrix parallel to the geometric insertion axis and describing the constant section of the cavity of the base, and
two side wings connected to the base, the two wings facing one another and delimiting a volume between them for receiving a universal joint journal cross, the two wings each being provided with a guide bearing housing for the universal joint journal cross, the two housings defining a pivot axis of the journal cross, perpendicular to the geometric insertion axis, and
a connecting bridge connecting the two side wings, the two bearing housings being situated between the base and the connecting bridge in reference to the insertion axis, wherein the connecting bridge comprises a through hole coaxial with the insertion axis, the through hole having a smooth inner cylindrical wall with a section situated in all points radially outside, or coinciding with, the geometric enclosure of the cavity of the base,
and wherein the second universal joint comprises comprising a male ball joint element housed, directly or indirectly, in the through hole of the first universal joint jaw that constitutes a female ball joint element.

16. The double universal joint according to claim 12, further comprising a sliding plastic pad inserted between a spherical portion of a ball joint element and a cylindrical portion of another ball joint element, the pad having a lower cavity for housing the spherical portion and an outer wall sliding in the cylindrical portion of the other ball joint element.

17. (canceled)

18. (canceled)
